(19) United States
(12) Patent Application Publication
(10) Pub. No.: US 2004/0268215 A1
(43) Pub. Date: Dec. 30, 2004

(54) System, method and computer program product for facilitating appointment-related actions

(75) Inventors: Dirk Trossen, Cambridge, MA (US); Dana Pavel, Cambridge, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/603,560

(22) Filed: Jun. 25, 2003

(51) Int. Cl. G06F 17/00

(52) U.S. Cl. 715/500

(57) ABSTRACT

A system is provided for facilitating an appointment-related action. The system includes an organizer and a mobile station. The organizer is capable of providing appointment information, and sending the appointment information, such as to the mobile station. In this regard, the appointment information includes an appointment, a starting action and an associated starting trigger time. The appointment information can also include an ending action and an associated ending trigger time. The mobile station is capable of receiving the appointment information. Thereafter, the mobile station can be triggered to perform the starting action at the associated starting trigger time, and can then perform the starting action. Similarly, the mobile station can be triggered to perform the ending action at the associated ending trigger time, and can then perform the ending action.

### FIELD OF THE INVENTION

The present invention generally relates to systems and methods for directing a mobile station to perform actions and, more particularly, relates to systems and methods for facilitating a mobile station performing actions based upon appointments, such as for meetings, events or the like.

### BACKGROUND OF THE INVENTION

Current mobile terminals provide a variety of mechanisms to alert users of incoming calls. The users can select the ringer type and volume and activate a voice mail service. The user may select how the mobile terminal responds to incoming calls. For example, while in a business meeting the user may program the mobile terminal to vibrate in response to incoming calls and while at a loud sporting event, the user may program the mobile terminal to increase the ringer volume level.

Current mobile terminals also include a variety of software applications. Some software applications allow users to document schedule information. Users typically review the status data stored with a schedule application and then manually program the response of the mobile terminal based on the schedule data, often referring to an appointment. For example, a common action triggered is displaying a reminder a certain time before the appointment. However, conventional Personal Information Manager (PIM) tools, such as Microsoft Outlook or Lotus Notes, lack the capability to define arbitrary pre-requisite actions to be triggered at some point prior to an appointment time.

Defining appointment-related actions to be triggered becomes even more important for invited attendant(s) of an appointment. For example, consider the context of controlling profiles within a mobile station. In the context of mobile stations, receiving calls, which are accompanied by alerts such as audible ringing, is often an annoyance for users of such mobile stations and others in the vicinity of the mobile stations. In most such instances, the user of the mobile station simply forgot to manually alter the alert profile in the mobile station, such as to a “silence” or “meeting” mode.

As an example of a current specification for providing the definition of a common format for openly exchanging calendaring and scheduling information across the Internet, consider the iCalendar specifications, as described by Internet Engineering Task Force (IETF) request for comment documents RFC 2445, entitled: Internet Calendaring and Scheduling Core Object Specification (iCalendar); RFC 2446 entitled: iCalendar Transport-Independent Interoperability Protocol (iTIP): Scheduling Events, Busy Time, To-dos and Journal Entries; and RFC 2447 entitled: iCalendar Message-Based Interoperability Protocol (iMIP), the contents of all of which are hereby incorporated by reference in their entirety. The current iCalendar specifications define a technique for creating appointment data. The specifications further allow for pre-requisite actions to be triggered at the time of, or prior to, the appointment. However, the specifications do not provide for commonly agreed semantics. In this regard, the envisioned actions in iCalendar denote executables that can be uploaded to the attendant (e.g., mobile station) for invocation. The current iCalendar specifications also do not provide for actions that can be triggered at the end of appointments. Further, the iCalendar specifications rely on iTIP for provisioning information from the organizer of the appointment or schedule information to the attendant, but iTIP does not provide for Web service-based transport.

### SUMMARY OF THE INVENTION

In light of the foregoing background, embodiments of the present invention provide an improved system, method, mobile station and computer program product for facilitating appointment-related actions. According to embodiments of the present invention, an appointment can include an appointment-related action that can be stored, such as by a mobile station, along with the appointment to thereby facilitate the mobile station performing the appointment-related action based upon the appointment. By including the appointment-related action with the appointment, the user of a mobile station, for example, need not manually alter the alert profile in the mobile station based upon an appointment maintained by the mobile station.

In the above example, then, consider that an organizer can send an appointment to a mobile station of a user, where the appointment is for a meeting at a designated time, and for a designated time period. According to embodiments of the present invention, the appointment can include an appointment-related action causing the mobile station to enter a “meeting” mode five minutes before the start of the meeting, where meeting mode causes the mobile station to disable audible ringing, such as upon receipt of a telephone call. Then, five minutes before the start of the meeting, the mobile station can automatically switch to meeting mode, independent of user interaction with the mobile station. Additionally, the appointment can include another appointment-related action causing the mobile station to enter a “normal” operating mode five minutes after the end of the meeting. In this regard, the mobile station can automatically switch to the normal operating mode after the meeting so that the user may thereafter again be notified of an incoming call by an audible ringing.

According to one aspect of the present invention, a system is provided for facilitating an appointment-related action. The system includes an organizer and a mobile station. The organizer is capable of providing appointment information, and sending the appointment information, such as to the mobile station. In this regard, the appointment information includes an appointment, a starting action and an associated starting trigger time. The appointment information can also include an ending action and an associated ending trigger time. Both actions may be described in the appointment information in a semantic notation that the organizer and the mobile station are capable of interpreting, such as in Resource Description Framework (RDF) and/or Extensible Markup Language (XML) formats. In this regard, the actions may be described a in previously agreed-upon semantic, such as through standardization.

The mobile station is capable of receiving the appointment information. Thereafter, the mobile station can be triggered to perform the starting action at the associated starting trigger time, and can then perform the starting action. Similarly, the mobile station can be triggered to perform the ending action at the associated ending trigger time, and can then perform the ending action. In this regard, one or both actions may be realized by the mobile station interpreting the provided description of the respective actions through appropriate means, such as using an Extensible Markup Language (XML) parser and appropriate software instructions to perform the parsed actions.

Before the mobile station is triggered to perform the starting action, the mobile station can receive acceptance of the appointment information. Then, if the appointment information is accepted, the mobile station can be triggered to perform the starting action. The mobile station can also be capable of confirming performance of the starting action, and even the ending action, before performing the starting action or ending action, respectively. In this regard, the mobile station can perform the starting or ending action if the starting or ending action, respectively, is confirmed.

The system can also include a gateway. The gateway is capable of receiving the appointment information from the organizer. Then, the gateway can format the appointment information for reception by the mobile station. Thereafter, the gateway can send the formatted appointment information to the mobile station.

According to other aspects of the present invention, a mobile station, method and computer program product for facilitating appointment-related actions are provided. Therefore, embodiments of the present invention provide an improved system, method, mobile station and computer program product for facilitating appointment-related actions. In this regard, the mobile station is capable of receiving appointments, such as from an organizer, where the appointments include associated appointment-related actions. By accepting the appointments and associated actions, the mobile station can perform the actions at specified times without being manually directed to perform the actions by the user. Also, according to embodiments of the present invention, the appointment can also include actions for the end of the appointments such that the mobile station can perform actions associated with the end of appointments. Therefore, the systems, methods, mobile stations and computer program products of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for facilitating performance of appointment-related actions according to one embodiment of the present invention;

FIG. 2 is a schematic block diagram of a mobile station that may act as either a user device, an organizer, or a gateway according to embodiments of the present invention;

FIG. 3 shows a functional diagram of a server, that may also act as either a user device, an organizer, or a gateway, according to embodiments of the present invention; and

FIG. 4 is a flow chart illustrating various steps in a method of facilitating performance of appointment-related actions according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the present invention are capable of defining trigger actions associated to calendar entries, such as altering a profile of a mobile station to enter a “meeting” or “silence” mode for a time period designated for a meeting in a calendar entry. For that, embodiments of the present invention provide for an organizer of an appointment to send appointment information to a user device, where the information typically includes at least an appointment start time and end time, action(s) to be triggered, and a time at which each action is to be triggered (default can be set for all appointments). Optionally, the information can also include, for example, location and other attendants associated with the appointment. Advantageously, the user device can include the organizer such that the mobile user defines the abovementioned appointment information, such as through appropriate an user interface directly on the user device. Once received, the appointment information can be stored by an appointment, or calendar, application operating on the user device, provided the user device receives consent to such storage, such as by a user of the user device.

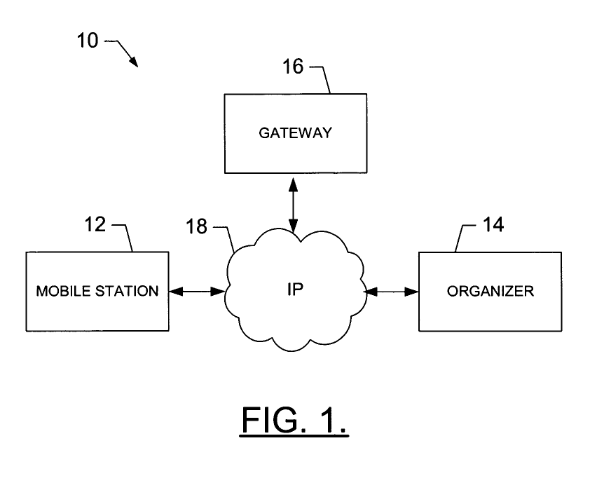

Referring now to FIG. 1, a general system 10 is shown that facilitates appointment-related actions. The system generally includes a user device 12 and an organizer 14, and may also include a gateway 16. The system also generally includes an IP communications network 18 through which the user device, the organizer and the gateway communicate, according to one embodiment of the present invention. Although the user device and organizer are illustrated as being distributed and capable of communicating over the IP network, it should be understood that, in various embodiments, the user device is capable of performing the functions of the organizer such that a single entity may support a logically separate, but co-located, user device with the organizer.

Generally, the organizer 14 is capable of sending an appropriate appointment, or appointment request, to the user device 12. The user device is capable of locally operating a calendar application, which in turn is capable of receiving the appointment, or appointment request. In this regard, the calendar application can comprise any of a number of different applications adapted to perform operations in accordance with embodiments of the present invention. For that, the calendar application may include the functionality to be capable of interpreting various electronic file formats required to interpret the actions specified by the organizer, as well as the functionality to be capable of invoking triggered actions, as described below. For example, the calendar application may be capable of interpreting electronic files that describe actions in Resource Description Framework (RDF) and/or Extensible Markup Language (XML) formats. More generally, the calendar application may be capable of interpreting appointment information describing actions in a format capable of being interpreted by the organizer and the mobile station.

The gateway 16 is capable of receiving appointment information, such as from the organizer 14, and thereafter forwarding the respective appointment information to the user device 12. In this regard, the gateway can operate in accordance with any of a number of different protocols, standards or the like, such as iMIP. The gateway may additionally, or alternatively, provide a Web service interface. For example, the gateway may provide a Web service interface in accordance with the Simple Object Access Protocol (SOAP), as such is described by D. Box et al., Simple Object Access Protocol V1.1, W3C Note NOTE-soap-20000508, World Wide Web Consortium (2000), the contents of which are hereby incorporated by reference in its entirety.

The gateway 16 is capable of acting as a bridge between Web service communication with the organizer 14, and iTIP communication with the user device 12. For example, the organizer may be capable of operating an appropriate Web Service, providing appointments/appointment requests to the gateway. The gateway, in turn may be capable of sending the appointment/appointment requests to the user device, such as in accordance with iTIP, where the appointment/appointment requests may be sent in the form of Smart Messages, Email messages or the like.

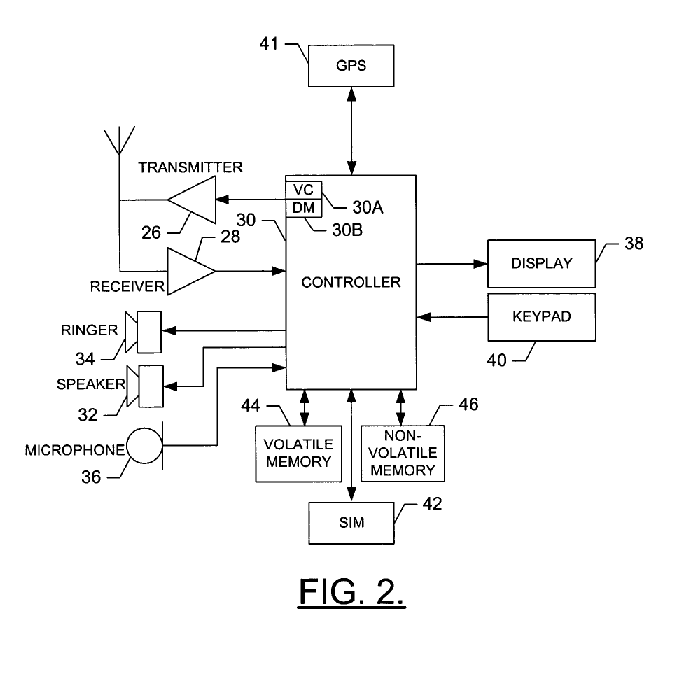

Referring now to FIG. 2, a functional diagram of a mobile station is shown that may act as either a user device 12, the organizer 14 or the gateway 16 according to embodiments of the invention. It should also be understood that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 26, a receiver 28, and a controller 30 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 30A, and may include an internal data modem (DM) 30B. Further, the controller may include the functionally to operate the calendar application, as well as one or more other software programs, applications or the like, which may be stored in memory. For example, in embodiments where the user device 12 is capable of performing the functions of the organizer 14, the controller also may be capable of operating an organizer application capable of receiving appointment information, and thereafter sending the appointment information to the calendar application, as described below.

The mobile station also comprises a user interface including a conventional earphone or speaker 32, a ringer 34, a microphone 36, a display 38, and a user input interface, all of which are coupled to the controller 30. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

In addition, the mobile station can include a positioning sensor, such as a global positioning system (GPS) sensor 41. In this regard, the GPS sensor is capable of determining a location of the mobile station, such as longitudinal and latitudinal directions of the mobile station. The mobile station can also include memory, such as a subscriber identity module (SIM) 42, a removable user identity module (R-UIM) or the like, which typically stores information elements related to a mobile subscriber. In addition to the SIM, the mobile station can include other memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can store an identifier, such as an international mobile equipment identification (IMEI) code, capable of uniquely identifying the mobile station, such as to a mobile switching center (MSC). Also, for example, the memories can store instructions for creating authorizations for access to resources controlled by the user, as described below.

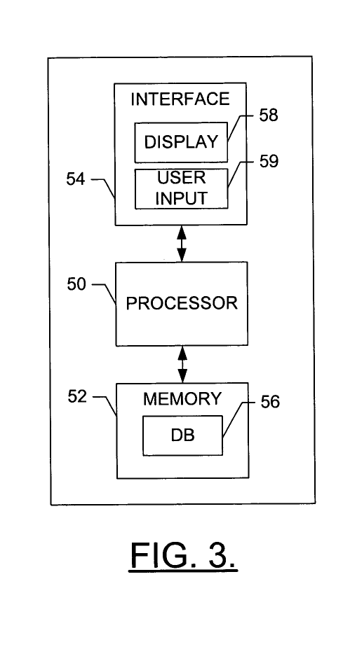

Reference is now drawn to FIG. 3, which illustrates another functional diagram of an entity that may act as either the user device 12, the organizer 14, or the gateway 16 according to embodiments of the invention. The entity acting as the user device, organizer or gateway generally includes a processor 50 connected to a memory 52 and a user interface 54. The memory typically includes instructions for the processor to perform steps associated with operating in accordance with embodiments of the present invention. As an organizer, the memory may store a local database 56 containing, for example, appointment information sent to one or more mobile stations. The user interface, which allows the entity to receive data, such as appointment information, can include any of a number of known elements. For example, the user interface can include a display 58 and a user input interface 59 (e.g., keyboard, mouse or the like), both of which are coupled to the processor.

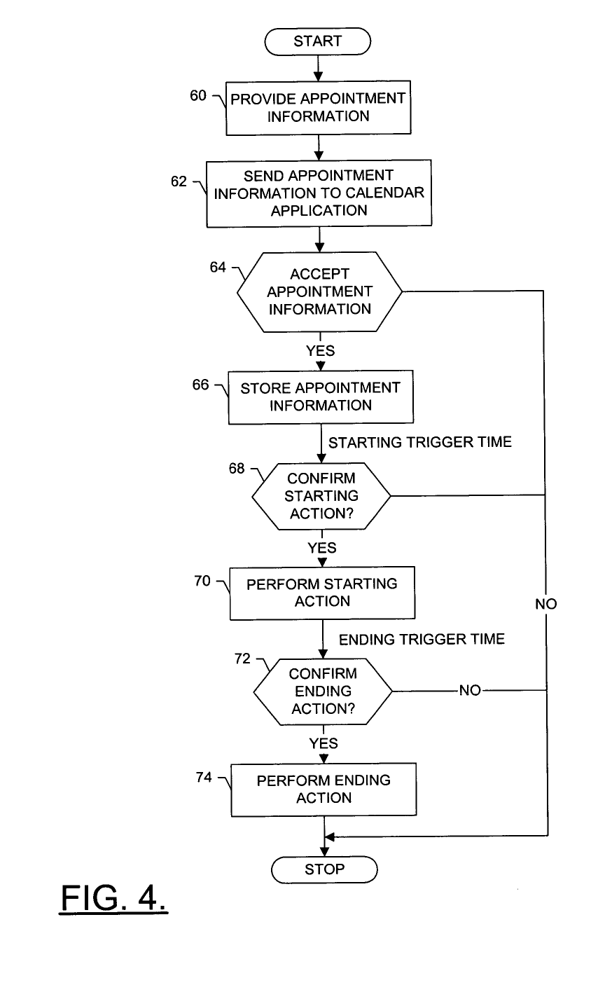

Generally, in accordance with embodiments of the present invention, the organizer 14 is capable of sending appointment information, including at least one action to be triggered, to the user device 12 such that a calendar application of the user device can direct the mobile station to perform the actions at the appropriate time(s) specified in the appointment information. Reference is now drawn to FIG. 4, which illustrates various steps in a method of facilitating appointment-related actions, according to one embodiment of the present invention. As shown in block 60, the method generally begins by providing appointment information defining an appointment, such as a reminder, meeting or the like. The appointment information can be provided in any of a number of different known manners, but is typically provided to the organizer 14, or the user device 12 in embodiments where the user device performs the functions of the organizer. For example, the appointment information can be provided to the organizer (or the user device in embodiments where the user device performs the functions of the organizer) via a user interface, such as user interface 54 as shown in FIG. 3.

The appointment information can include any of a number of different pieces of information associated with an appointment. For example, the appointment information can include a name or other identifier for the appointment, as well as starting and ending times. Additionally, in accordance with embodiments of the present invention, the appointment information can include at least one action, such as a starting action and an ending action, to be performed by the user device. In this regard, the actions can comprise any of a number of different actions capable of being performed by the user device. As will be understood, however, the actions are typically defined such that the organizer and the user device are both capable of interpreting the actions in a consistent manner, such as by defining the actions based upon a consistent, standardized semantic defining the actions.

The appointment information can also include at least one trigger time, such as a starting trigger time and an ending trigger time, defining the times at which the mobile station is triggered to perform the actions (e.g., starting and ending actions). As will be appreciated, the trigger times can be the same as, or different from, the starting and ending times. The trigger times, as well as the starting and ending times, can be defined in any of a number of different manners. For example, the trigger times can be defined as an absolute time (e.g., 1:30 pm). Alternatively, for example, the trigger times can be defined in relative terms based, directly or indirectly, upon an absolute time. For example, an ending trigger time can be defined as an hour past the starting time of the appointment, where the starting time of the appointment is defined as an absolute time. Also, for example, an ending trigger can be defined as an hour past the starting trigger time, where the starting trigger time is defined as fifteen minutes before the starting time of the appointment.

In addition to the aforementioned pieces of information, the appointment information can include other types of information. For example, the appointment information can include information such as a location associated with the appointment and/or attendants associated with the appointment. As will be appreciated, the appointment information can be provided in any of a number of different formats. For example, the appointment information can be provided in accordance with the iCalendar specifications, or extensions thereof. In this regard, the appointment information can be provided in RDF- or XML-based formats, without departing from the spirit and scope of the present invention. Additionally or alternatively, for example, the actions (e.g., starting and/or ending actions) included within the appointment information can be provided as an executable, such as in accordance with the iCalendar specifications.

After the appointment information has been provided, the appointment information can be sent to the calendar application of the user device 12, as shown in block 62. The appointment information can be sent to the calendar application according to any of a number of different techniques. According to one technique, for example, the user device performs the functions of the organizer by operating an organizer application, and as such, the organizer application can send the appointment information to the calendar application locally within the user device, according to any of a number of known techniques.

According to another technique where the organizer 14 communicates with the user device 12 via the IP communications network 18, the organizer can send the appointment information to the user device either directly or indirectly. The appointment information can be sent according to any of a number of different techniques. For example, the appointment information can be sent as email-based iCalendar-conform information in accordance with the iCalendar specifications.

In yet another technique, the appointment information can be sent to the user device 12 via the gateway 16. According to this technique, the organizer 14 can send a message to the gateway, where the message includes the appointment information and identifies the user device through a unique address, such as phone number or uniform resource identifier (URI). In one typical scenario, a Web service can be implemented at the gateway, and provided to the organizer, such as according to SOAP. The Web service can then allow for providing the appointment information to the gateway. Whether or not a Web service is implemented at the gateway, the gateway can receive a message, such as a SOAP message, and thereafter create an appropriate message to be sent to the user device, where the message to the user device includes the appointment information. The message to the user device can comprise any of a number of different formats, such as Wireless Application Protocol (WAP) push, enhanced SMS messages (so-called Smart Messages), or the like.

Regardless of how the appointment information is sent to the user device 12, once the user device receives the appointment information, the user device can forward the appointment information internally to the calendar application. Alternatively, the appointment information can be forwarded to any of a number of other internal elements, devices, systems or software applications capable of interpreting the appointment information in accordance with embodiments of the present invention. For example, the appointment information may be forwarded to an appropriate extension of a conventional calendar application, where the extension may be operated, for example, as a stand-alone application, a function of the conventional calendar application, or a replacement for the conventional calendar application (at least as far as interpreting appointment information in accordance with embodiments of the present invention).

If desired (e.g., defined in the preferences of the calendar application), the calendar application can then direct the user device to present, such as via a display (e.g., display 38, 58), a request for the user to accept all, or a portion of, the appointment information, as shown in block 64. In this regard, the request can include all, or any portion of, the appointment information, including the name of the appointment, and the actions to be triggered at respective trigger times. For example, a request can indicate a business meeting with phone profile changes as to-be-triggered actions of this meeting. The dialog box can therefore request consent from the user to perform the specified actions at the specified time.

Once presented, the user device 12 can receive acceptance of at least a portion of the appointment information from the user. If the user accepts the appointment information, the user device stores the appointment information, as shown in block 66. If the user does not accept the appointment information, however, the user device typically does not store the appointment information. As will be appreciated, the user may be capable of accepting a portion of the appointment information, with the user device storing the accepted portion of the appointment information. For example, the user may be capable of accepting the appointment information without accepting the actions to be performed at the trigger times. Whether the user device accepts or denies the appointment information, the user device may be capable of sending a confirmation back to the organizer 14, such as indicating an “accept,” “deny,” or “tentative” with respect to the appointment information.

Once the user device 12, or more particularly the calendar application on the user device, has stored the appointment information, at the starting trigger time, the calendar application directs the user device to perform the starting action. Before directing the user device to perform the starting action, however, the user device can again present a display requesting confirmation to perform the starting action, as shown in block 68. Then, if the user device receives confirmation, the calendar application can trigger the user device to perform the starting action, as shown in block 70. In this regard, the calendar application can be capable of interpreting the appointment information, such as according to XML and/or RDF techniques, to trigger performance of the starting action.

The starting action can direct, and the user device 12 can perform, any of a number of different actions in accordance with operation of the user device. For example, when the user device comprises a mobile station, the starting action can direct the user device to alter a profile on the mobile station so as to change settings such as ring tone, voicemail options or the like. Apart from local actions, however, the starting action can direct the user device to perform a number of actions remote from the user device, such as by modifying state information at a Session Initiation Protocol (SIP) proxy local to the user device to thereby enable various call control features. Additionally, or alternatively, the starting action can direct the user device, or more particularly the calendar application of the user device, to upload altered presence information to a SIP presence server to thereby enable presence-based call control features that depend upon calendar data. For more information on such actions, see U.S. patent application Ser. No. 10/329,996, entitled: Context Sensitive Call Processing, filed Dec. 26, 2002; and U.S. patent application Ser. No. 10/320,636, entitled: Dynamic User-State Dependent Processing, filed Dec. 17, 2002, the contents of both of which are hereby incorporated by reference in their entirety.

After performing the starting action, at the ending trigger time, the calendar application can trigger the user device 12 to perform the ending action. Like with the starting action, however, the user device can present a display requesting confirmation of performing the ending action before performing the ending action, as shown in block 72. In such an embodiment, if the ending action is confirmed, the user device can perform the ending action, as shown in block 74. In this regard, the ending action can comprise any of a number of different actions, such as those described above in conjunction with the starting action, which oftentimes reverses the changes implemented in conjunction with the starting action.

The preceding embodiment of the present invention included both a starting and ending action, with corresponding starting and ending trigger times. It should be understood, however, that the appointment information need not include both a starting and an ending action. In this regard, the appointment information can include a starting action and starting trigger time, and not include an ending action or ending trigger time. Similarly, the appointment information can include an ending action and ending trigger time, and not specify a starting action or starting trigger time.

Embodiments of the present invention are applicable to any of a number of a different contexts relating to appointments, calendar entries or the like. For example, in one exemplar scenario, the organizer 14 is associated with, or otherwise under the control of, the host of an entertainment event such as a concert or movie. In such a scenario, as the user of the user device 12, such as a mobile station, purchases a ticket online for such an event, the organizer can send an appropriate calendar entry (i.e., appointment) to the mobile station, either directly or indirectly, such as through the gateway 16. In this regard, the calendar entry can include desired phone profiles for this event, such as “silence mode” for the duration of the event, and “normal” at the end of the event. Then, presuming the user of the mobile station accepts the appointment information including the calendar entry, the mobile station can automatically switch to silence mode at the specified starting trigger time and back to “normal” profile at the specified ending trigger time, after the event.

In another exemplar scenario, the organizer 14 is associated with, or otherwise under the control of, an airline. Prior to boarding the aircraft (which can be highly dynamic due to the time-varying nature of flights), the airline can dispatch appointment information to the mobile stations of all passengers, where the necessary data to dispatch such information is assumed to be available to the airline. The appointment information can include a desired phone profile for the flight, such as “switch-off” for the duration of the flight. The starting action further indicates that the mobile station should not permanently store the appointment. Upon reception and acceptance of the appointment information, the passengers' phones automatically switch off without actually storing the appointment. In contrast to the preceding example, it will be noted that here the appointment information does not define an ending action, such as “switch-on phone,” in order to avoid false phone activation during a prolonged flight.

According to one aspect of the present invention, the system of the present invention, such as the controller 30 of the mobile station, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 4 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for facilitating an appointment-related action comprising:
sending appointment information to a calendar application operating on a mobile station, wherein the appointment information includes an appointment, a starting action and an associated starting trigger time;
receiving the appointment information;
triggering the mobile station to perform the starting action at the associated starting trigger time; and
performing the starting action.

2. A method according to claim 1 further comprising:
receiving acceptance of the appointment information before triggering the mobile station; and
confirming performance of the starting action before performing the starting action,
wherein triggering the mobile station comprises triggering the mobile station if the appointment information is accepted, and wherein performing the starting action comprises performing the starting action if performance of the starting action is confirmed.

3. A method according to claim 1, wherein the appointment information further includes an ending action and an associated ending trigger time, wherein the method further comprises:
triggering the mobile station to perform the ending action at the associated ending trigger time; and
performing the ending action, and wherein triggering the mobile station to perform the ending action and performing the ending action occur after performing the starting action.

4. A method according to claim 3 further comprising:
confirming performance of the ending action before performing the ending action wherein performing the ending action comprises performing the ending action if performance of the ending action is confirmed.

5. A method according to claim 1 further comprising:
sending the appointment information to a gateway; and
formatting the appointment information for reception by the mobile station, wherein sending the appointment information to a gateway and formatting the appointment information occur before sending the appointment information to the calendar application.

6. A method according to claim 1, wherein sending appointment information comprises sending, from an organizer to a mobile station, appointment information in a format capable of being interpreted by the mobile station and the organizer.

7. A method according to claim 6, wherein sending appointment information in a format capable of being interpreted by the mobile station and the organizer comprises sending appointment information in at least one of a Resource Description Framework (RDF) and an Extensible Markup Language (XML) format.

8. A method according to claim 6 further comprising:
interpreting the appointment information based upon the format of the appointment information, and thereafter triggering the mobile station to perform the starting action based upon the interpretation.

9. A system for facilitating an appointment-related action comprising:
an organizer capable of providing appointment information, wherein the appointment information includes an appointment, a starting action and an associated starting trigger time, and wherein the organizer is also capable of sending the appointment information;
a mobile station capable of receiving the appointment information, wherein the mobile station is capable of being triggered to perform the starting action at the associated starting trigger time, and thereafter performing the starting action.

10. A system according to claim 9, wherein the mobile station is capable of receiving acceptance of the appointment information before being triggered to perform the starting action, wherein the mobile station is capable of being triggered to perform the starting action if the appointment information is accepted, and wherein the mobile station is capable of confirming performance of the starting action before performing the starting action, and thereafter performing the starting action if performance of the starting action is confirmed.

11. A system according to claim 9, wherein the appointment information further includes an ending action and an associated ending trigger time, and wherein the mobile station is also capable of being triggered to perform the ending action at the associated ending trigger time, and thereafter performing the ending action.

12. A system according to claim 11, wherein the mobile station is also capable of confirming performance of the ending action before performing the ending action, and thereafter performing the ending action if performance of the ending action is confirmed.

13. A system according to claim 9 further comprising:
a gateway capable of receiving the appointment information from the organizer, wherein the gateway is capable of formatting the appointment information for reception by the mobile station, and thereafter sending the formatted appointment information to the mobile station.

14. A mobile station comprising:
a receiver capable of receiving appointment information, wherein the appointment information includes an appointment, a starting action and an associated starting trigger time; and
a controller capable of operating a calendar application, wherein the calendar application is capable of receiving the appointment information from the receiver, and thereafter triggering the mobile station to perform the starting action at the associated starting trigger time.

15. A mobile station according to claim 14, wherein the calendar application is capable of receiving acceptance of the appointment information before triggering the mobile station to perform the starting action, wherein the calendar application is capable triggering the mobile station to perform the starting action if the appointment information is accepted, and wherein the calendar application is capable of confirming performance of the starting action before the mobile station performs the starting action such that the mobile station performs the starting action if performance of the starting action is confirmed.

16. A mobile station according to claim 15 further comprising:
a display capable of presenting a request for a user to accept the appointment information before the calendar application receives the acceptance, wherein the display is also capable of presenting a request to confirm performance of the starting action before the calendar application confirms performance.

17. A mobile station according to claim 12, wherein the appointment information further includes an ending action and an associated ending trigger time, and wherein the calendar application is also capable of triggering the mobile station to perform the ending action at the associated ending trigger time.

18. A mobile station according to claim 17, wherein the calendar application is also capable of confirming performance of the ending action before the mobile station performs the ending action such that the mobile station performs the ending action if performance of the ending action is confirmed.

19. A computer program product for facilitating an appointment-related action of a mobile station, the computer program product comprising a computer-readable storage medium having computer-readable program code portions stored therein, the computer-readable program portions comprising:
a first executable portion for receiving appointment information, wherein the appointment information includes an appointment, a starting action and an associated starting trigger time; and
a second executable portion for triggering the mobile station to perform the starting action at the associated starting trigger time.

20. A computer program product according to claim 19, wherein the second executable portion is capable of receiving acceptance of the appointment information before triggering the mobile station to perform the starting action such that the second executable portion triggers the mobile station to perform the starting action if the appointment information is accepted, and wherein the second executable portion is capable of confirming performance of the starting action before the mobile station performs the starting action such that the mobile station performs the starting action if performance of the starting action is confirmed.

21. A computer program product according to claim 19 further comprising:
a third executable portion for directing a display to present a request for a user to accept the appointment information before the second executable portion receives the acceptance, wherein the third executable portion is also capable of directing the display to present a request to confirm performance of the starting action before the second executable portion confirms performance.

22. A computer program product according to claim 19, wherein the appointment information further includes an ending action and an associated ending trigger time, and wherein the second executable portion is also capable of triggering the mobile station to perform the ending action at the associated ending trigger time.

23. A computer program product according to claim 22, wherein the second executable portion is also capable of confirming performance of the ending action before the mobile station performs the ending action such that the mobile station performs the ending action if performance of the ending action is confirmed.
